(19) United States
(12) Patent Application Publication
(10) Pub. No.: US 2024/0130386 A1
(43) Pub. Date: Apr. 25, 2024

(54) VEGETABLE CHEESE ANALOGUE

(71) Applicant: Oatly AB, MAMÖ (SE)

(72) Inventors: Ida Andersson, MALMÖ (SE); Olivia Arbab, MALMÖ (SE); Anna Forslund, MALMÖ (SE); Sofia Ehlde, MALMÖ (SE); Karin Petersson, MALMÖ (SE)

(21) Appl. No.: 18/277,968

(22) PCT Filed: Feb. 19, 2021
(86) PCT No.: PCT/EP2021/054208

§ 371 Date: Aug. 17, 2023

(51) Int. Cl. A23C 20/02

(52) U.S. Cl. CPC A23C 20/02

(57) ABSTRACT

A vegetable cheese analogue has an oat base having dry matter in an amount of 2-8% by weight of the cheese analogue, a vegetable fat in an amount of 20-30% by weight of the cheese analogue, at least one starch in an amount of 20-30% by weight of the cheese analogue, at least one vegetable protein in an amount of 1-4% by weight of the cheese analogue, at least one stabilizer in an amount of 0.2-1% by weight of the cheese analogue, and water in an amount of 35-45% by weight of the cheese analogue.

### TECHNICAL FIELD OF INVENTION

The present invention relates to a vegetable cheese analogue.

### BACKGROUND

Cheese analogues, also known as, for example, cheese alternatives, are products used as replacements or as alternatives for traditional dairy cheese. Such analogues may contain both dairy and non-dairy components depending on the use and consumer of the final product. There is a growing population which refrain from consumption of dairy products as well from meat products, for example for health reasons, religious reasons, and sustainability reasons. There is a growing trend, to choose products for consumption in the daily life which contribute to a positive climate impact. This may mean excluding or at least reducing intake of dairy containing products as well as meat products. The population consuming only vegetables, vegetarians, and vegans, is growing and the interest for such products is expected to grow.

There are non-dairy cheese analogues available on the market, but there is a need and demand for cheese analogues having desirable texture and taste to suit the consumer. Prior art vegan cheese analogues are known to have floury or sandy mouthfeel, gum like texture and being crumbly. With higher requirements on taste and texture there is a continued need for new products which are appealable to the growing consumer population as well as providing health effects and are sustainable from an environmental perspective. It is a further need to be able to provide cheese analogues suitable for preparation and cooking.

### SUMMARY OF THE INVENTION

In the light of the above, it is an object of the present inventive concept to provide a vegetable cheese analogue, such as a starch-based cheese analogue, wherein the above-mentioned disadvantages of the prior art are addressed.

According to a first aspect of the present inventive concept there is provided a vegetable cheese analogue such as a starch-based cheese analogue with an oat content. The cheese analogue comprises: an oat base comprising dry matter in an amount of 2-8% by weight of the cheese analogue; a vegetable fat present in an amount of 20-30% by weight of the cheese analogue; at least one starch present in an amount of 20-30% by weight of the cheese analogue; at least one vegetable protein present in an amount of 1-4% by weight of the cheese analogue; at least one stabilizer present in an amount of 0.2-1% by weight of the cheese analogue; and water present in an amount of 35-45% by weight of the cheese analogue.

The combination of ingredients or features provides a vegetable cheese analogue having an improved texture. The cheese analogue as provided has reduced crumbliness, as compared e.g. to other known cheese analogues, including, for example, a reduced crumbling feeling in the mouth, which makes it more pleasant to consume. In addition, it has been shown that the cheese analogue of the invention may be described as malleable and being easier to form into a desired shape. Thus, technical features such as texture, elasticity, and formability of the cheese analogue of the invention have been improved.

According to a second aspect of the present inventive concept, there is provided a method for manufacturing of a vegetable cheese analogue, the method comprising: melting of vegetable fat; providing a mixture of oat base, the vegetable fat from the melting, at least one starch, at least one vegetable protein, at least one stabilizer, and water, and, optionally, additional ingredients; heating and mixing of the mixture; pasteurizing the mixture after heating and mixing; and shaping of cheese analogues.

According to a third aspect of the present inventive concept, there is provided a vegetable cheese analogue obtainable by the method according to the second aspect.

Features from the first aspect may be relevant also for the second or third aspects, and vice versa.

### BRIEF DESCRIPTION OF THE DRAWINGS

Aspects of the present disclosure will now be described in more detail, with reference to the appended drawings showing embodiments and examples, in which:

FIG. 1 disclose a table with the different components of the cheese analogues 1-6 as prepared in example 2.

FIG. 2 discloses pictures of cheese analogue 1 and 5. The cheese analogue 1 broke when rolled, but cheese analogue 5 produced a roll when rolled.

FIG. 3 illustrates a method for manufacturing of a vegetable cheese analogue.

### DETAILED DESCRIPTION

The present invention will now be described more fully hereinafter. This invention may, however, be embodied in many different forms and should not be construed as limited to the embodiments set forth herein; rather, these embodiments are provided for thoroughness and completeness, and for fully convey the scope of the invention to a skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realisations that vegetable cheese analogues with desirable properties, including eg. having improved texture and reduced crumbliness, may be provided having a content of oat base and further ingredients comprising vegetable protein and stabiliser.

According to a first aspect of the present inventive concept there is provided a vegetable cheese analogue such as a starch-based cheese analogue with an oat content. The cheese analogue comprises: an oat base comprising dry matter in an amount of 2-8% by weight of the cheese analogue; a vegetable fat present in an amount of 20-30% by weight of the cheese analogue; at least one starch present in an amount of 20-30% by weight of the cheese analogue; at least one vegetable protein present in an amount of 1-4% by weight of the cheese analogue; at least one stabilizer present in an amount of 0.2-1% by weight of the cheese analogue; and water present in an amount of 35-45% by weight of the cheese analogue. The combination of ingredients or features provides a vegetable cheese analogue having an improved texture. The cheese analogue as provided has reduced crumbliness, as compared e.g. to other known cheese analogues, including, for example, a reduced crumbling feeling in the mouth, which makes it more pleasant to consume. In addition, it has been shown that the cheese analogue of the invention may be described as malleable and being easier to form into a desired shape. Thus, technical features such as texture, elasticity, and formability of the cheese analogue of the invention have been improved.

The oat base may, for example, be provided in dry form during manufacturing of the vegetable cheese analogue, whereby water present in the vegetable cheese analogue may be provided as liquid water and/or as steam. Further, the oat base may be provided as a liquid or aqueous oat base during manufacturing of the vegetable cheese analogue. Thus, the oat base may be a liquid oat base. The oat base may be an oat drink, for example a liquid product sometimes referred to as an oat milk. The water present in an amount of 35-45% by weight of the cheese analogue may be the total water provided as liquid and/or steam water during manufacturing of the vegetable cheese analogue, and any water present in the oat base for a case where the oat base is provided in non-dry form. For the purpose of improving understanding, the vegetable cheese analogue may be obtained using a liquid or aqueous oat base comprising, for example, 1-20% by weight of dry matter, such as 5-15% by weight, e.g. 10-15%, such as 14%, and 99-80% by weight of water, and any additional water may be provided up to 35-45% by weight of the vegetable cheese analogue.

The oat base may be provided in an amount of 2-8% dry matter by weight of the cheese analogue which allows for introduction of beneficial properties to the cheese analogue. The oat base may provide for example flavor, color, texture, and structure to the cheese analogue, as well as, for example, providing a source of proteins, vegetable fat and fibers. For example, the oat-base may provide β-glucans to the cheese analogue, which in combination with other ingredients of the cheese analogue may provide health-beneficial properties, which may include assisting in lowering cholesterol levels and blood sugar levels. The oat-base may further provide natural sugars which may, for example, add flavor to the fat composition.

The oat base may be described as obtained from treatment of oats with suitable enzymes such as amylase, optionally followed by fermentation. For example, α- and/or β-amylase may be used. Thereby, the oat base may comprise one, more or all of monosaccharides, disaccharides, for example, maltose, oligosaccharides, and/or fiber, for example β-glucans. The oat base may further comprise proteins and fat from the oats. All or part of unreacted or partly reacted starch and fibers from the oats may be removed or reduced in content in the treatment of the oats or prior to the addition of the oat-base to the vegetable cheese analogue.

Thus, the oat base may comprise components selected from the group consisting of fat, saturated fat, monounsaturated fat, polyunsaturated fat, carbohydrates, sugars, preferably maltose, fiber, protein, and beta glucan, and combinations thereof. It is realized that the components of the oat base such as fat and protein are in addition to the components as claimed in the cheese analogue.

The oat base may be obtained from treatment of oats comprising treatment with an enzyme such as amylase, for example as has been described in patent No. EP 1 383 396 B1.

The oat base may comprise beta glucan as stated above, and thereby the cheese analogue of the invention may provide the beneficial health properties that beta glucans are known to normally have.

The vegetable fat present in the cheese analogue may comprises 45-65% of saturated fat, which may be hydrogenated fat, 22-32% of monounsaturated fat, which may be non-hydrogenated, and 8-18% of polyunsaturated fat, which may be non-hydrogenated, by weight of the vegetable fat. In an embodiment of the invention the vegetable fat comprises 50-60% of saturated fat, 24-30% of monounsaturated fat, and 11-15% of polyunsaturated fat, by weight of the vegetable fat. In another preferred embodiment the vegetable fat comprises 55% of saturated fat, 27% of monounsaturated fat, and 13% of polyunsaturated fat, by weight of the vegetable fat.

The vegetable fat may comprise 50-60% of saturated fat, 24-30% of monounsaturated fat, and 11-15% of polyunsaturated fat, by weight of the vegetable fat.

The vegetable fat may comprise one or more, or two or more, of rapeseed fat, coconut fat and rapeseed oil. Thereby, the vegetable fat as used in the cheese analogue may be designed or composed with suitable and desirable properties.

The vegetable fat may comprise at least one, preferably two or more, type of fats selected from the group consisting of rapeseed fat, coconut fat, and rapeseed oil. In addition, a part may present as oat oil or oat fat from the oat base. It is realized that any other vegetable oil or fat may be used than the ones mentioned above.

The vegetable fat may comprise two or more type of fats selected from the group consisting of rapeseed fat (hydrogenated), coconut fat (hydrogenated), rapeseed oil (non-hydrogenated). In an embodiment, the amount of rapeseed fat (hydrogenated) is 1-27% by weight and rapeseed oil (non-hydrogenated) 37-63% by weight and the amount of coconut fat (hydrogenated) is present in an amount of 36% by weight of the vegetable fat.

Put in other words, the amount rapeseed fat (hydrogenated) and rapeseed oil (non-hydrogenated) present in the vegetable fat may be in an amount of 54-74%, such as 59-69%, e.g. about 64% by weight and the coconut fat (hydrogenated) in an amount of 26-46%, such as 30-42%, e.g. about 36% by weight. If the fat is present as a hydrogenated fat, it may be melted prior to addition during manufacturing of the cheese.

The vegetable fat may comprise 45-65% of saturated fat, 22-32% of monounsaturated fat, and 8-18% of polyunsaturated fat, by weight of the vegetable fat. Thereby, properties of the fat may be selected to suit the desired end product, i.e. desirable cheese analogue intended for cooking or baking or for consumption directly. In an embodiment, the vegetable fat comprises 50-60% of saturated fat, 24-30% of monounsaturated fat, and 11-15% of polyunsaturated fat, by weight of the vegetable fat.

The vegetable fat may comprise, going from a larger portion by weight to a smaller portion by weight of the vegetable fat: non-hydrogenated rapeseed oil, hydrogenated coconut fat, and hydrogenated rapeseed fat.

The water may be present in an amount of 35 to 45% by weight, such as, 36 to 44%, 37 to 43, e.g. 38-42% by weight of the cheese analogue.

The cheese analogue may comprise at least one starch, such as native starch or modified starch, for example modified potato starch. The modified potato starch may be an acid treated potato starch. The modified potato starch may be present as a combination of acid treated potato starch, hydroxypropylated distarch phosphate of potato origin and pregelatinized starch sodium octenyl succinate. Modified starches, such as modified potato starches, may have improved functional properties compared to native starches. Modified starches can be prepared with desirable properties and degree of substitution by critically selecting a suitable modifying agent, suitable reaction conditions, and a native starch source. The challenges in the field of starch modification include the development and use of modification methods that are friendly to the environment and safe for the consumer. The starch may be present as a native or natural starch as is available from many different sources such as corn, maize, rice, quinoa, tapioca, and cereals such as wheat, oat, rye, and barley. Any other starch source not mentioned here may naturally be used in the concept of the present invention.

The cheese analogue may comprise at least one vegetable protein chosen from potato protein, pea protein, legume protein, or a combination thereof. Said protein may be used alone, such as potato protein, or a combination of two or more of said proteins may be used together. It is realized that the mentioned proteins may naturally be exchanged for any other available vegetable protein known within the technical field.

The at least one stabilizer as used in the cheese analogue may comprise xanthan gum. The at least one stabilizer may be selected from xanthan gum and additional and/or similar stabilizers, and combinations thereof.

Xanthan gum may be present in an amount of 0.2-1% by weight of the cheese analogue. For example, xanthan gum may be present in an amount of 0.3-0.8% by weight of the cheese analogue, such as 0.4-0.6% by weight of the cheese analogue.

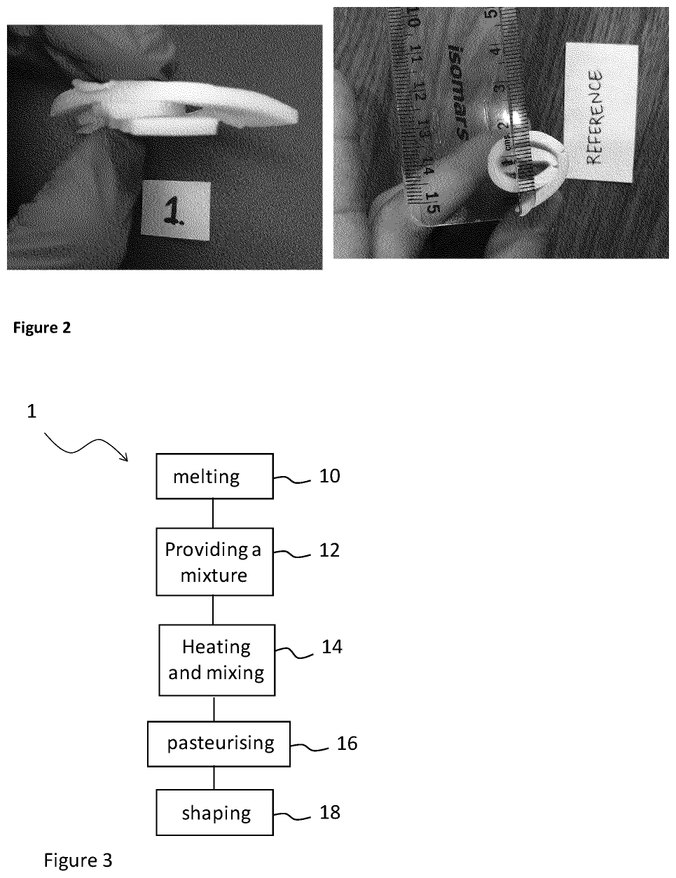

The xanthan gum improves the final cheese analogue in that it contributes to reducing the crumbly feeling in the mouth when the cheese analogue is consumed, even though it is the entire combination of components that provides the cheese analogue with the improved features. It has been shown in the examples that for the present cheese analogue the presence of the stabilizer such as xanthan gum in combination with added protein such as potato protein in certain amounts is important for the mouthfeel and flexibility of the final cheese analogue. The mouthfeel is improved in that cheese analogue is smooth and not crumbly. In addition, once the cheese is sliced, it is possible to roll the obtained slice, see FIG. 2. Such features are important for the consumer. Outside the claimed range of these components it is not possible to roll the cheese slice because the flexibility is not as good, and the mouthfeel is crumbly.

The cheese analogue may further comprise additional components such as salt, acidity regulator, natural coloring agent, natural flavoring agent, vitamins. The amount of said additional components may be adjusted to a desired level to reach a certain requirement such as color or taste.

In an embodiment of the invention, the cheese analogue comprises;
an oat base comprising dry matter in an amount of 3-7% by weight of the cheese analogue;
a vegetable fat present in an amount of 23-27% by weight of the cheese analogue; and comprises 45-65% of saturated fat, 22-32% of monounsaturated fat, and 8-18% of polyunsaturated fat, by weight of the vegetable fat;
at least one starch present in an amount of 21-25% by weight of the cheese analogue;
at least one vegetable protein present in an amount of 1-4% by weight of the cheese analogue;
at least one stabilizer present in an amount of 0.2-1% by weight; and
water in an amount of 38-42% by weight.

In another embodiment of the invention, the cheese analogue comprises;
an oat base comprising dry matter in an amount of about 5% by weight of the cheese analogue;
a vegetable fat present in an amount of about 25% by weight of the cheese analogue; and comprises 55% of saturated fat, 27% of monounsaturated fat, and 13% of polyunsaturated fat, by weight of the vegetable fat;
at least one starch present in an amount of about 23% by weight of the cheese analogue;
at least one vegetable protein present in an amount of about 2% by weight of the cheese analogue;
at least one stabilizer present in an amount of about 0.5% by weight; and water.

The cheese analogue as provided according to the invention may be characterized as resembling a hard cheese and is suitable for consumption instead of an ordinary hard cheese. For instance, it may be easily sliced and thereby suitable for consumption. The texture has been improved both in terms of mouth feeling with reduced crumbling, and formability of the cheese analogue has also been improved, i.e. it is easier to form into shapes, such as rolling a slice of cheese analogue.

In an embodiment, the cheese analogue is gluten-free which is beneficial for an additional part of the population. In such case the oat base as used in the cheese analogue is gluten-free. The cheese analogue may be soy-free and/or gluten-free.

The cheese analogue, as described herein, has an improved mouthfeel in that the cheese analogue is smooth and not crumbly. In addition, once the cheese is sliced in thin slices (about 3 mm), it is possible to roll the obtained slice, see FIG. 2. Such features are important for the consumer. Below the claimed range, i.e. below 1% by weight protein and below 0.2% by weight xanthan gum, it is not possible to roll the cheese slice as desired, likely resulting from the flexibility not being sufficiently good. The mouthfeel is also crumbly. In addition, when increasing the amount of protein and xanthan gum, the cheese analogue loses its pleasant mouthfeel and develops a doughy feeling. It is unlikely that such a cheese analogue will be suitable to slice in large scale.

It has also been shown that the obtained cheese slices of the cheese analogue of the invention melts nicely on for instance a sandwich when heated in an oven. The cheese analogue may be considered to be a starch-based cheese analogue with an oat content having beneficial properties as described above.

The vegetable composition may alternatively be described as a plant-based, a vegan, a non-dairy and/or a vegetarian vegetable cheese analogue. The vegetable cheese analogue may be totally free from animal ingredients. However, the vegetable cheese analogue may contain additives derived from animal sources, and still be according to embodiments described herein, although not preferred.

With reference to FIG. 3, the second aspect of the present inventive concept will now be described. FIG. 3 illustrates a method 1 for manufacturing of a vegetable cheese analogue. The method 1 comprises: melting 10 of vegetable fat; providing a mixture 12 of oat base, the vegetable fat from the melting, at least one starch, at least one vegetable protein, at least one stabilizer, and water, and, optionally, additional ingredients; heating and mixing 14 of the mixture; pasteurizing 16 the mixture after heating and mixing; and shaping 18 of cheese analogues.

The melting 10 of vegetable fat may be melting of fats separately.

The providing a mixture 12, may comprise mixing of the at least one stabilizer and the at least one starch; and mixing of the, thus obtained mixture of stabilizer and starch with other ingredients.

The method according to the second aspect may be for manufacturing of a vegetable cheese analogue described according to the first aspect.

The mixture may comprise an oat base comprising dry matter in an amount of 2-8% by weight of the cheese analogue; a vegetable fat present in an amount of 20-30% by weight of the cheese analogue; at least one starch present in an amount of 20-30% by weight of the cheese analogue; at least one vegetable protein present in an amount of 1-4% by weight of the cheese analogue; at least one stabilizer present in an amount of 0.2-1% by weight of the cheese analogue; and water present in an amount of 35-45% by weight of the cheese analogue.

It shall be realized that the melting 10 of vegetable fat may be relevant for fats in hard or solid form, but not for e.g. oil or otherwise liquid fats.

According to a third aspect of the present inventive concept, there is provided a vegetable cheese analogue obtainable by the method according to the second concept.

Different vegetable cheese analogues will now be described.

### EXAMPLES

### Example 1—Method of Manufacturing Cheese Analogue

### Mild Flavor Cheese Analogue:

Vegetable fat (hydrogenated rapeseed and coconut fat, and rapeseed oil) present in 25% by weight was melted separately at 50°-60° C. and in parallel 0.5% by weight xanthan gum (stabilizer) and 2% by weight potato protein were premixed. Thereafter, all of the remaining components including 33.25% by weight oat base, 23% by weight modified potato starch (blend of acid treated potato starch, hydroxypropylated distarch phosphate of potato origin and pregelatinized starch sodium octenyl succinate of potato origin), 12% steam water, 1% by weight tri-calcium phosphate, 2% by weight non-iodized salt, 0.5% by weight lactic acid (acidity regulator), 0.05% by weight natural colouring agent and 0.68% by weight natural cheese flavoring agent and 0.0033% by weight vitamin mix were mixed with the oil and the premix for about 30 s at 500 rpm.

Thereafter the mixture was heated and mixed for about 120 s at 50° C., 800 mbar at 15000 rpm and thereafter for about 90 s at 85° C., 800 mbar at 3000 rpm. Then the mixture was pasteurized for about 120 s at 85° C., 800 mbar at 3000 rpm. Thereafter, the mixture was hot filled in molds and subjected to air blast chilling.

The oat base was a liquid oat base, an oat drink, obtained via starch degradation by means of amylases, and having 14% dry solids.

### Medium Flavor Cheese Analogue:

Vegetable fat (hydrogenated rapeseed and coconut fat, and rape seed oil) present in 25% was melted separately at 50°−60° C. and in parallel 0.5% by weight xanthan gum (stabilizer) and 2% by weight potato protein were premixed. Thereafter all of the remaining components including 33.10% by weight oat base, 23% by weight modified potato starch (blend of acid treated potato starch, hydroxypropylated distarch phosphate of potato origin and pregelatinized starch sodium octenyl succinate of potato origin), 12% steam water, 1% by weight tri-calcium phosphate, 2% by weight non-iodized salt, 0.5% by weight lactic acid (acidity regulator), 0.05% by weight natural coloring agent, 0.825% by weight natural cheese flavoring agent and 0.0033% by weight vitamin mix were mixed with the oil and the premix for about 30 s at 500 rpm.

Thereafter the mixture was heated and mixed for about 120 s at 50° C., 800 mbar at 15000 rpm and thereafter for about 90 s at 85° C., 800 mbar at 3000 rpm. Finally the mixture was pasteurized for about 120 s at 85° C., 800 mbar at 3000 rpm. Thereafter, the mixture was hot filled in molds and subjected to air blast chilling.

The oat base was a liquid oat base, an oat drink, obtained via starch degradation by means of amylases, and having 14% dry solids.

### Example 2

The aim of this example was to show what impact, at different dosages, xanthan gum and potato protein have together on the final cheese analogue. It was also tested with and without oat base. Six different cheese analogues were prepared with different components. The cheese analogues were prepared similar to descriptions of Example 1, where relevant.

### Cheese Analogue 1:

It was tested to reduce the amount of xanthan gum and potato protein compared to cheese analogue 5 (embodiment of the invention). 80% less xanthan and protein was used (oat base included). When inspecting a slice (3 mm) of the cheese analogue it could be observed a less homogenous texture. When consuming a slice, the mouthfeel is dry and sandy or floury afterwards. In addition, the slice is not possible to roll. Instead, breakage of the cheese analogue slice is observed, see FIG. 2 left hand figure. Thus, using an amount of the stabilizer and protein below the claimed range does not provide a desirable cheese analogue. The presence of <0.4% potato protein and <0.1% xanthan gum impairs the homogenous and smooth mouthfeel of the finished product, i.e. causing a sandy texture which is noticeable when consuming the cheese

### Cheese Analogue 2:

Secondly, it was tested to increase the amount of xanthan gum and potato protein compared to cheese analogue 5. 50% more xanthan gum and protein was used (oat base included). When inspecting a slice of the cheese analogue it could be observed a more homogenous texture compared to cheese analogue 1. When consuming a slice, the mouthfeel is very soft and slightly doughy compared to the cheese analogue 5. It is unlikely that this cheese analogue will be possible to slice in large scale. Thus, using an amount of the stabilizer and protein above the claimed range does not provide a desirable cheese analogue.

Cheese Analogue 3: 80% Less Xanthan and Protein, without Oat Base, Having Replaced Oat Base with Water.

The same amount was used as in cheese analogue 1 except for that the oat base was excluded and replaced with water. When consuming a slice, the mouthfeel is softer and doughier compared to cheese analogue 5. Thus, this cheese analogue does neither produce a desirable cheese analogue with desirable properties. It is unlikely that this cheese analogue will be possible to slice in large scale, water instead of oat base is believed to contribute to negative effects, e.g. including too soft and doughy sensation.

Cheese Analogue 4: 50% More Xanthan and Protein, without Oat Base

The same amount was used as for cheese analogue 2 except for that the oat base was excluded and replaced with water. A very flexible and porous feeling of the obtained cheese analogue was obtained. The increased softness decreases the likelihood of the cheese to be sliced/cut in large scale in a feasible manner.

Cheese Analogue 5: Embodiment of the Invention, with Oat Base

The amount of xanthan gum (0.5% by weight) and protein (2% by weight) is within the claimed range (oat base included). When inspecting a slice of the cheese analogue it could be observed a beneficial texture. When consuming a slice, the mouthfeel is pleasant with a nice chewing resistance, but is also soft. In addition, it is possible to roll the cheese slice, see FIG. 2 right hand. Both the cheese analogue produced in a laboratory and in a factory could be rolled nicely, especially the one made in the factory. The presence of 2%-3% potato protein and 0.5%-0.75% xanthan gum has a positive effect on the flexibility of the finished products texture, e.g. facilitating the possibility to role as thick as 3 mm slices.

Cheese analogue 6: Without Oat Base

The same amount was used as for cheese analogue 5 except for that the oat base was excluded and replaced with water. The obtained cheese analogue was not as beneficial as that obtained for cheese analogue 5. The absence of oat base (14% dry matter in oat base), i.e. by the replacement of water, decreases the overall texture (g)/resistance of the cheese causing a doughy mouthfeel and does also decrease the likelihood of the cheese to be sliced/cut in large scale in a feasible manner.

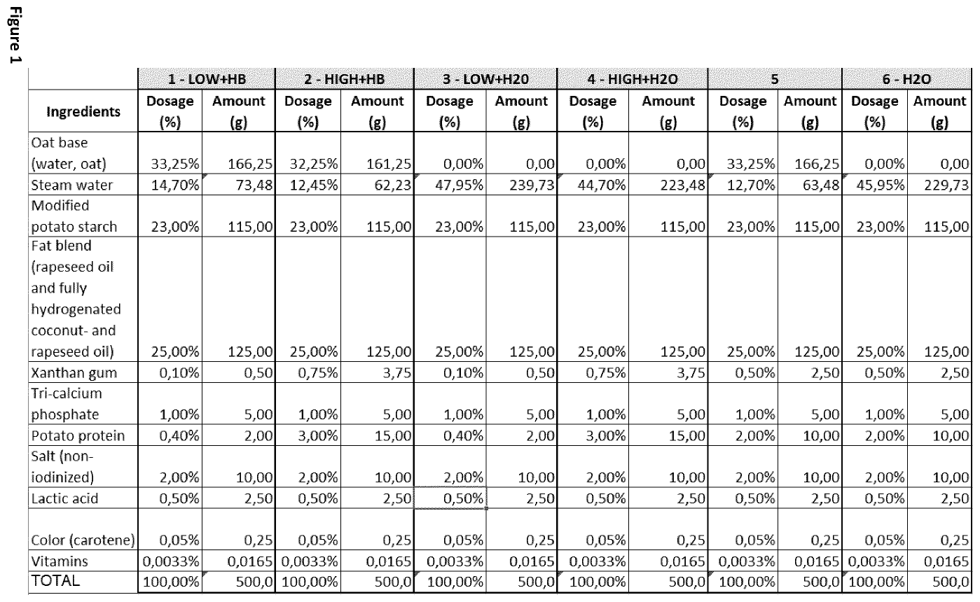

### Details of the Components of the Cheese Analogues 1-6 are Disclosed in FIG. 1.

A comparison of the cheese analogues 1 and 5, when a slice is rolled, is disclosed in FIG. 2, in which the picture to the left illustrates a slice of cheese analogue 1, and the figure to the right illustrates a roll of a slice of cheese analogue 5.

Texture was determined to be 304 g, 345 g, 311 g, 259 g, 431 g, and 320 g for the cheese analogues 1 to 6 fig, respectively. Texture was measured using a Brookfield Texture Analyzer cT3, with a 2 cm long, 2 mm diameter cylinder probe. The settings were: Trigger, 3.0 g; deformation, 20 mm; and speed, 1.5 mm/second.

From the above experiments it is clear that the specific amount of the stabilizer and protein as present in the cheese analogue is very important for the properties such as texture and mouthfeel of the final cheese analogue. In addition, the oat-base is also important, since it is clearly also shown that removing the oat-base and replacing it with water does not provide the same beneficial properties (cheese analogue 5 (oat base) and 6 (oat base replaced with water) may be compared for this purpose). Content of oat base improves texture as compared to a content of water instead of oat base. Protein and xanthan according to embodiments results in improved texture, which texture is further improved with oat base, in the combination of the ingredients.

1. A vegetable cheese analogue comprising:
an oat base comprising dry matter in an amount of 2-8% by weight of the cheese analogue;
a vegetable fat present in an amount of 20-30% by weight of the cheese analogue;
at least one starch present in an amount of 20-30% by weight of the cheese analogue;
at least one vegetable protein present in an amount of 1-4% by weight of the cheese analogue;
at least one stabilizer present in an amount of 0.2-1% by weight of the cheese analogue; and
water in an amount of 35-45% by weight of the cheese analogue.

2. A cheese analogue according to claim 1, wherein the oat base comprises fat, saturated fat, monounsaturated fat, polyunsaturated fat, carbohydrates, sugars, preferably maltose, fiber, protein, and beta glucan, and combinations thereof.

3. A cheese analogue according to claim 1, wherein the at least one stabilizer is xanthan gum.

4. A cheese analogue according to claim 1, wherein the oat base has been obtained from treatment of oats with any enzyme.

5. A cheese analogue according to claim 1, wherein the starch is selected from the group consisting of native starch and modified starch, and combinations thereof.

6. A cheese analogue according to claim 1, wherein said at least one starch comprises modified potato starch.

7. A cheese analogue according to claim 1, wherein said at least one vegetable fat comprises 45-65% of saturated fat, 22-32% of monounsaturated fat, and 8-18% of polyunsaturated fat, by weight of the vegetable fat.

8. A cheese analogue, according to claim 7, wherein said at least one vegetable fat comprises 50-60% of saturated fat, 24-30% of monounsaturated fat, and 11-15% of polyunsaturated fat, by weight of the vegetable fat.

9. A cheese analogue according to claim 1, wherein the at least one vegetable protein is potato protein, pea protein, legume protein, or a combination of thereof.

10. A cheese analogue according to claim 1, wherein the cheese analogue further comprises additives selected from salt, acidity regulator, natural coloring agent, natural flavoring agent, and vitamins.

11. A cheese analogue according to claim 1, wherein the cheese analogue comprising:
an oat base comprising dry matter in an amount of 3-7% by weight of the cheese analogue;
at least one vegetable fat present in an amount of 23-27% by weight of the cheese analogue; and comprises 45-65% of saturated fat, 22-32% of monounsaturated fat, and 8-18% of polyunsaturated fat, by weight of the vegetable fat;
at least one starch present in an amount of 21-25% by weight of the cheese analogue;
at least one vegetable protein present in an amount of 1-4% by weight of the cheese analogue;
at least one stabilizer present in an amount of 0.2-1% by weight of the cheese analogue; and
water in an amount of 38-42% by weight.

12. A cheese analogue according to claim 11, wherein the analogue comprising:
an oat base comprising dry matter in an amount of 5% by weight of the cheese analogue;
at least one vegetable fat present in an amount of 25% by weight of the cheese analogue; and comprises 55% of saturated fat, 27% of monounsaturated fat, and 13% of polyunsaturated fat, by weight of the vegetable fat;
at least one starch present in an amount of 23% by weight of the cheese analogue;
at least one vegetable protein present in an amount of 2% by weight of the cheese analogue;
at least one stabilizer present in an amount of 0.5% by weight of the cheese analogue; and
water.

13. A cheese analogue according to claim 1, wherein said cheese analogue is gluten-free.

14. A method for manufacturing of a vegetable cheese analogue, the method comprising:
melting of vegetable fat,
providing a mixture of oat base, the vegetable fat from the melting, at least one starch, at least one vegetable protein, at least one stabilizer, and water,
heating and mixing of the mixture,
pasteurizing the mixture after heating and mixing, and
shaping of cheese analogues.

15. (canceled)

16. A vegetable cheese analogue obtainable by the method of claim 14.

17. The method according to claim 14, wherein the vegetable cheese analogue comprises:
the oat base comprising dry matter in an amount of 2-8% by weight of the cheese analogue;
the vegetable fat present in an amount of 20-30% by weight of the cheese analogue;
the at least one starch present in an amount of 20-30% by weight of the cheese analogue;
the at least one vegetable protein present in an amount of 1-4% by weight of the cheese analogue;
the at least one stabilizer present in an amount of 0.2-1% by weight of the cheese analogue; and
water in an amount of 35-45% by weight of the cheese analogue.

18. The cheese analogue according to claim 4, wherein the enzyme is an amylase.

19. The cheese analogue according to claim 4, wherein the treatment of the oats is followed by fermentation.

20. The method of claim 14, wherein the mixture further comprises additional ingredients.
